(19) United States
(12) Patent Application Publication
(10) Pub. No.: US 2005/0052153 A1
(43) Pub. Date: Mar. 10, 2005

(54) Electronic device

(75) Inventors: Hirofumi Fujisaki, Tokyo (JP); Masatoshi Kobayashi, Tokyo (JP); Tomoyasu Fukui, Tokyo (JP); Toshiaki Honda, Tokyo (JP)

Correspondence Address: MORGAN LEWIS & BOCKIUS LLP, 1111 PENNSYLVANIA AVENUE NW, WASHINGTON, DC, 20004, US

(73) Assignee: Uniden Corporation

(21) Appl. No.: 10/654,622

(22) Filed: Sep. 4, 2003

(51) Int. Cl. H02J 7/00

(52) U.S. Cl. 320/114

(57) ABSTRACT

It is an object of the present invention to prevent overdischarge of the secondary battery installed inside an electronic deice and to increase waterproofing ability of the electronic device. In order to attain this object, the electronic device of the present invention comprises a secondary battery, a main circuit which is operated by receiving power supply from the secondary battery, and a switch for ON/OFF controlling power supply from the secondary battery to the main circuit. With such a configuration, the secondary battery can be installed in the electronic device in advance at the electronic device shipping stage and waterproofing ability of the components accommodating the secondary battery can be improved. Furthermore, if the switch is switched off at the electronic device shipping stage, overcharge of the secondary battery can be prevented and the electronic device can be stored for a long time with the secondary battery contained therein.

### BACKGROUND OF THE INVENTION

1. Field of the Invention

The present invention relates to an electronic device with a secondary battery installed therein, and more particularly to an improved technology for preventing overdischarge of the secondary battery and improving a waterproofing function.

2. Description of the Related Art

Portable electronic devices such as cordless phones, video cameras, shavers, and the like, are widely spread, those devices containing a secondary battery allowing the device to be conveniently used without connection to a household power source. If an electronic device is shipped after the secondary battery has been installed therein, the secondary battery continues discharging via a connection circuit even in a power source OFF state. Therefore, if the electronic device is stored for a long time, there is a risk of the secondary battery being overdischarged before the electronic device will be delivered to the user. For this reason, the secondary battery is usually not installed inside the electronic device at a product shipping stage and is packaged separately, and the user, after purchasing the product, opens the battery lid of the electronic device and installs the secondary battery.

However, if an electronic device body is provided with an open/close structure such as a battery lid or the like to allow the secondary battery to be installed or removed, in the electronic devices requiring waterproofing ability, water can penetrate into the electronic device through the gaps of the open/close structure, thereby causing a problem associated with reduced waterproofing capability.

### SUMMARY OF THE INVENTION

Accordingly, it is an object of the present invention to prevent overdischarge of the secondary battery installed inside an electronic deice and to increase waterproofing ability of the electronic device.

In order to attain this object, the electronic device comprises a secondary battery, a main circuit which is operated by receiving power supply from the secondary battery, and a switch for ON/OFF controlling power supply from the secondary battery to the main circuit. With such a configuration, the secondary battery can be installed in the electronic device in advance at the electronic device shipping stage and waterproofing ability of the components accommodating the secondary battery can be improved. Furthermore, if the switch is switched off at the electronic device shipping stage, overcharge of the secondary battery can be prevented and the electronic device can be stored for a long time with the secondary battery contained therein.

The switch preferably has a waterproofed structure. With such a configuration, the waterproofing performance of the electronic device can be improved.

Furthermore, it is preferred that the switch have a configuration such that switching by the user's input operation cannot be conducted after the switch has been switched from OFF to ON. Because the secondary battery supplies power necessary for the operation of the main circuit, it is desired that a configuration be employed which prevents the switch from being easily switched off in a usual utilization mode.

Furthermore, the electronic device in accordance with the present invention is preferably a waterproofed portable electronic device. Waterproofing performance of the electronic device can be improved by installing a secondary battery inside the electronic device in advance and obtaining a configuration in which the secondary battery cannot be easily removed.

### BRIEF DESCRIPTION OF THE DRAWINGS

FIG. 1 illustrates a circuit configuration of the electronic device of the present embodiment;

FIG. 2 illustrates an external appearance of the electronic device of the present embodiment.

FIG. 3 is a cross-sectional view of a slide switch in a slide-off state; and

FIG. 4 is a cross-sectional view of a slide switch in a slide-on state.

### DESCRIPTION OF THE PREFERRED EMBODIMENTS

The preferred embodiments of the present invention will be described hereinbelow with reference to the appended drawings.

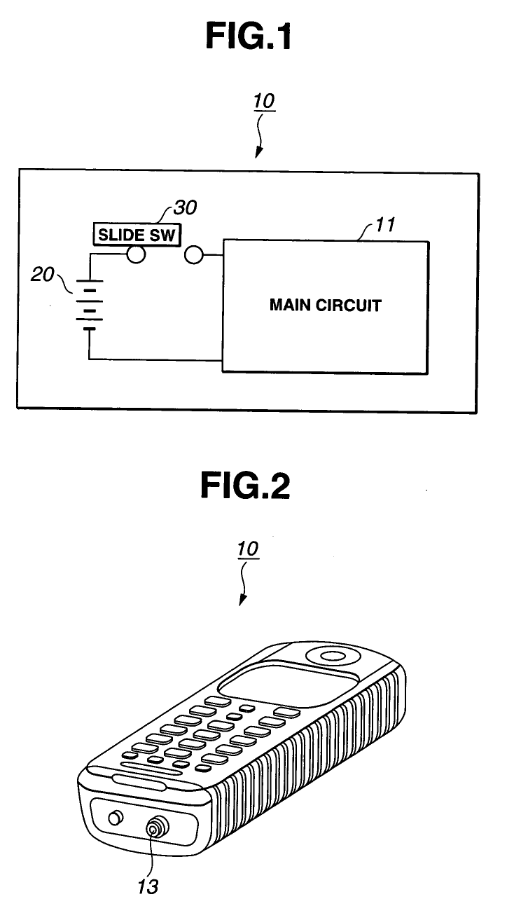

FIG. 1 illustrates a circuit configuration of an electronic device 10 of the present embodiment. A secondary battery 20 is installed in advance, at a product shipping stage, in the electronic device 10, and a power supply circuit is constructed so that electric power can be supplied from the secondary battery 20 to a main circuit 11 via a slide switch 30. The main circuit 11 is an electronic circuit serving to realize the functions of the electronic device 10. The ON/OFF control of the power supply circuit is implemented with the slide switch 30, and power supply from the secondary battery 20 to the main circuit 11 can be switched by placing the slide switch 30 in the ON/OFF positions. At the product shipping stage, the slide switch 30 is set to OFF and the electric connection of the secondary battery 20 to the main circuit 11 is interrupted.

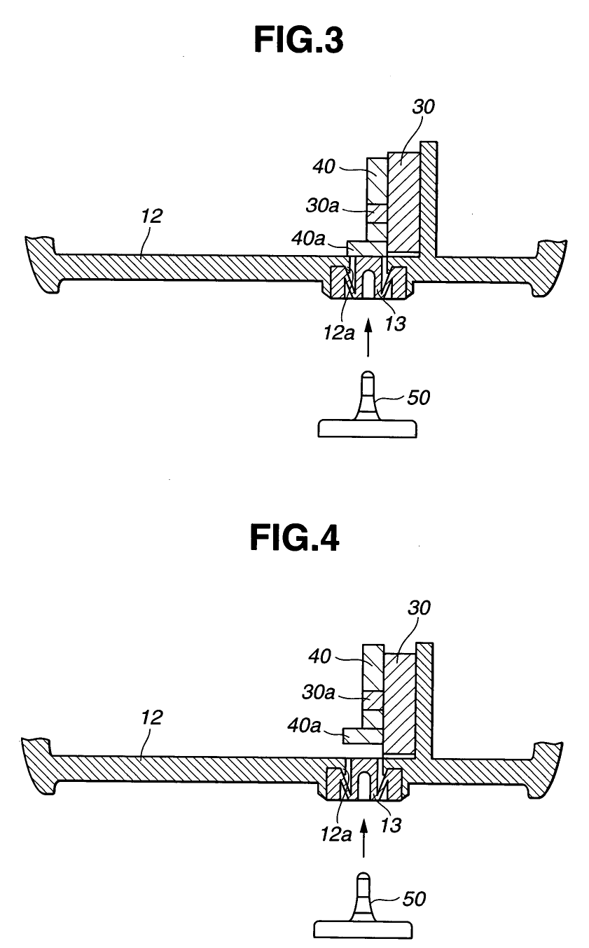

FIG. 3 and FIG. 4 illustrate cross-sectional structures of the above-mentioned slide switch 30. In the state shown in FIG. 3, the slide switch 30 is switched off, and in the state shown in FIG. 4, the slide switch 30 is switched on.

The slide switch 30 is provided with a knob 30a which is constructed so as to be free to slide, and ON/OFF control of the slide switch 30 can be conducted by slide operating the knob 30a. The knob 30a is fit in a knob slide 40 which is slidably guided inside a case 12, and switchover of the slide switch 30 is controlled by slide operating the knob slide 40. An insertion hole 12a having an inner diameter sufficient to insert a jig pin 50 is formed in the case 12 of the electronic device 10, and switchover of the slide switch 30 can be conducted by inserting the jig pin 50 in the insertion hole 12a and causing the knob slide 40 to slide.

The slide switch 30 has a waterproofed structure, the configuration being such as to prevent the penetration of water into the case 12 as a result of switchover operation. More specifically, as shown in the figure, a waterproofing member 13 having elasticity and made, for example, from a rubber or a resin is inserted into a recessed portion of the insertion hole 12a, thereby maintaining the inside of the case 12 in an air-tight state. The waterproofing member 13 has a U-like cross section and is attached by an appropriate pressure to the wall surface of the insertion hole 12a. If the jig pin 50 is inserted in the insertion hole 12a, the waterproofing member 13 is pushed by the jig pin 50. As a result, the water-proof member 13 is extended inside the case 12, applying pressure to a pressure portion 40a of the knob slide 40.

If the knob slide 40 is slid upward, as shown in the figure, the switch-on state is attained, as shown in FIG. 4. If now the slide switch 30 is switched ON, the knob slide 40 cannot be caused to slide in the direction switching off the slide switch 30. Therefore, the knob slide is held in a state in which the electric connection of the secondary battery 20 and the main circuit 11 is maintained. Because the secondary battery 20 supplies electric power necessary for operating the main circuit 11, it is desired to have a configuration in which the slide switch 30 cannot be switched off in a normal utilization mode.

FIG. 2 shows an external appearance of the electronic device 10, which is focused on the waterproofing member 13. In terms of design, it is preferred that the bottom or rear surface of the electronic device 10 serve as an attachment position for the waterproofing member 13, as shown in the figure.

Furthermore, as described hereinabove, with the present embodiment, providing the slide switch 30 in the power circuit for supplying power of the secondary battery 20 to the main circuit 11 makes it possible to install the secondary battery 20 inside the electronic device 10 in advance at the product shipping stage. As a result, it is not necessary to create a configuration allowing the user to install the secondary battery 20 inside the electronic device 10. Therefore, the structure of the components accommodating the secondary battery 20 can be strengthened and waterproofing capability of the electronic device 10 can be improved.

Furthermore, overdischarge of the secondary battery 20 can be avoided by switching off the slide switch 30 at the product shipping stage and providing a configuration such that the slide switch 30 can be easily switched on by the users manual operation. Therefore, the product can be stored for a long time.

Further, taking into account the service life of the secondary battery 20, it is desired to use a structure of the components accommodating the secondary battery 20 such that the secondary battery 20 can be removed without disassembling the electronic device 10. Moreover, not only the above-described slide switch 30, but any switch can be used as the switch for opening and closing the power circuit for supplying power from the secondary battery 20 to the main circuit 11, provided that this switch can be switched by the user's input operation. It is desired that the switch have a configuration such that switching by the user's input operation cannot be conducted after the switch has been switched from OFF to ON.

The electronic device using the present invention is preferably a portable electronic device such as a cellular phone, a cordless phone, a transceiver, a digital camera, a video camera, and the like, more preferably an electronic device requiring waterproofing ability.

1. An electronic device comprising:
a secondary battery;
a main circuit which is operated by receiving power supply from said secondary battery; and
a switch for ON/OFF controlling power supply from said secondary battery to said main circuit.

2. The electronic device according to claim 1, wherein said switch has a waterproofed structure.

3. The electronic device according to claim 2, wherein said switch is constructed so that the switchover by a user's input operation is impossible after the switch has been switched from OFF to ON.

4. The electronic device according to any of claims 1 to 3, wherein said electronic device is a waterproofed portable electronic device.
